(19) United States
(12) Patent Application Publication
(10) Pub. No.: US 2024/0186062 A1
(43) Pub. Date: Jun. 6, 2024

(54) PRINTED COIL AND ANTENNA TUNING

(71) Applicant: JABIL INC., St. Petersburg, FL (US)

(72) Inventors: NATHANIEL RICHARDS, St. Petersburg, FL (US); SAI AVUTHU, St. Petersburg, FL (US); MARK SUSSMAN, St. Petersburg, FL (US); SAMANTHA STEVENS, St. Petersburg, FL (US); ARNOLD RETA, St. Petersburg, FL (US); NABEL GHALIB, St. Petersburg, FL (US); BEN LIESEGANG, St. Petersburg, FL (US); JÖRG RICHSTEIN, St. Petersburg, FL (US); ED COLLINS, St. Petersburg, FL (US)

(21) Appl. No.: 18/556,124

(22) PCT Filed: Apr. 19, 2022
(86) PCT No.: PCT/US2022/071791

§ 371 Date: Oct. 19, 2023

Related U.S. Application Data
(60) Provisional application No. 63/176,659, filed on Apr. 19, 2021.

(51) Int. Cl. H01F 41/04; G06K 19/077

(52) U.S. Cl. CPC H01F 41/043; G06K 19/07773

(57) ABSTRACT

A method for flexible hybrid electronics (FHE) simultaneous printing of a plurality of electrical devices. The method includes providing a flexible substrate having a top surface and a bottom surface and providing vias through the substrate for all of the plurality of electrical devices. The method also includes printing circuit elements for the plurality of devices on the top surface of the substrate using a conductive ink, and printing circuit elements for the plurality of devices on the bottom surface of the substrate using the conductive ink, where printing the circuit elements on the top and bottom surfaces of the substrate causes the ink to flow through the vias to provide an electrical connection between the circuit elements on the top and bottom surfaces.

### BACKGROUND

### Field

This disclosure relates generally to a method for flexible hybrid electronics (FHE) simultaneous printing of a plurality of electrical devices and, more particularly, to a method for FHE simultaneous printing of a plurality of electrical devices that includes drilling vias through a flexible substrate, printing circuit elements for a plurality of electrical devices on a top surface of the substrate using a conductive ink, and printing circuit elements for the plurality of electrical devices on a bottom surface of the substrate using the conductive ink, where printing the circuit elements on the top and bottom surfaces of the substrate causes the ink to flow through the vias to provide an electrical connection between the circuit elements on the top and bottom surfaces.

### Discussion

Flexible hybrid electronics (FHE) is a process for creating flexible, stretchable or conformable electrical devices. More specifically, an FHE process combines elements of the electronics industry with elements of the high-precision printing industry to combine the best of printed and conventional electronics. The FHE process includes printing conductive interconnects and as many electrical components as possible on a flexible substrate. Integrated circuits (IC) are produced separately using photolithography and then mounted to the substrate. The FHE process uses a hybrid of printed and placed functionality that provides the flexibility long associated with printed electronics, but with the processing capability of an integrated circuit. This combination of flexibility and processing capability is very desirable since it reduces weight and enables new form factors, while maintaining desirable functionality, such as data logging and Bluetooth connectivity. Improvements can be made to existing FHE processes to reduce cost and complexity and increase performance of electrical devices.

### SUMMARY

The following discussion discloses and describes a method for FHE simultaneous printing of a plurality of electrical devices. The method includes providing a flexible substrate having a top surface and a bottom surface and providing vias through the substrate for all of the plurality of electrical devices. The method also includes printing circuit elements for the plurality of devices on the top surface of the substrate using a conductive ink, and printing circuit elements for the plurality of devices on the bottom surface of the substrate using the conductive ink, where printing the circuit elements on the top and bottom surfaces of the substrate causes the ink to flow through the vias to provide an electrical connection between the circuit elements on the top and bottom surfaces.

Additional features of the disclosure will become apparent from the following description and appended claims, taken in conjunction with the accompanying drawings.

### BRIEF DESCRIPTION OF THE DRAWINGS

FIG. 1 is a top view of an RFID device assembly including RFID devices having antennas fabricated by an FHE process;

FIG. 2 is a bottom view of the assembly shown in FIG. 1;

FIG. 3 is a top view of another RFID device assembly including RFID devices having antennas fabricated by an FHE process;

FIG. 4 is a flow diagram showing an FHE process for fabricating the assembly shown in FIG. 3;

FIG. 5 is a flow diagram showing a process for forming vias in a substrate associated with the process shown in FIG. 4; and

FIG. 6 is a top view of one of the RFID devices shown in FIG. 3 separated from the assembly.

### DETAILED DESCRIPTION OF THE EMBODIMENTS

The following discussion of the embodiments of the disclosure directed to a method for FHE simultaneous printing of a plurality of electrical devices is merely exemplary in nature, and is in no way intended to limit the disclosure or its applications or uses.

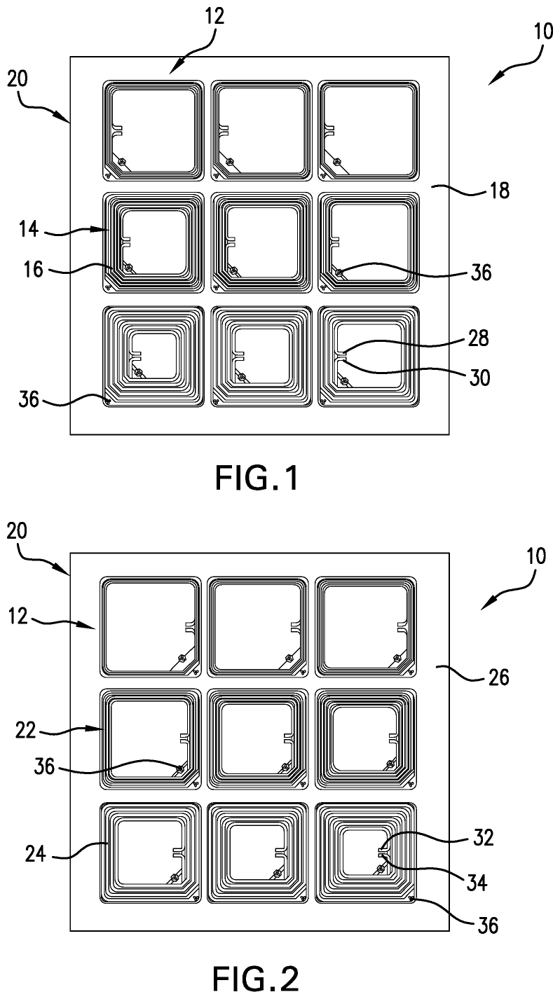

FIG. 1 is a top view and FIG. 2 is a bottom view of an RFID device assembly 10 fabricated by an FHE process. The assembly 10 includes a plurality of RFID devices 12, here nine, each having an RFID antenna 14 including a wound conductive trace 16 printed on a top surface 18 of a flexible substrate 20, such as a polyester substrate, and an RFID antenna 22 including a wound conductive trace 24 printed on a bottom surface 26 of the flexible substrate 20. Opposing ends 28 and 30 of the trace 16 extend towards a center of the antenna 14 and opposing ends 32 and 34 of the trace 24 extend towards a center of the antenna 22, and each provide an electrical connection point for an electrical component (not shown), such as an RFID chip. A number of vias 36 are drilled through the substrate 20 prior to the traces 16 and 24 being printed using a conductive ink, such as a silver ink, so that when the traces 16 and 24 are printed, the conductive ink flows into the vias 36 and makes an electrical connection between the antennas 14 and 22 through the substrate 20. Once the RFID antennas 14 and 22 are fabricated and the components are attached to the ends 28 and 30 of the trace 16 and the ends 32 and 34 of the trace 24, the substrate 20 is diced to separate the RFID devices 12. The conductive traces 16 from one RFID antenna 14 to another RFID antenna 14 and likewise the conductive traces 24 from one RFID antenna 22 to another RFID antenna 22 are shown as having different widths, number of turns and trace spacing for illustrative purposes to show that the fabrication of different RFID devices operating at different frequencies and for different applications can be fabricated at the same time.

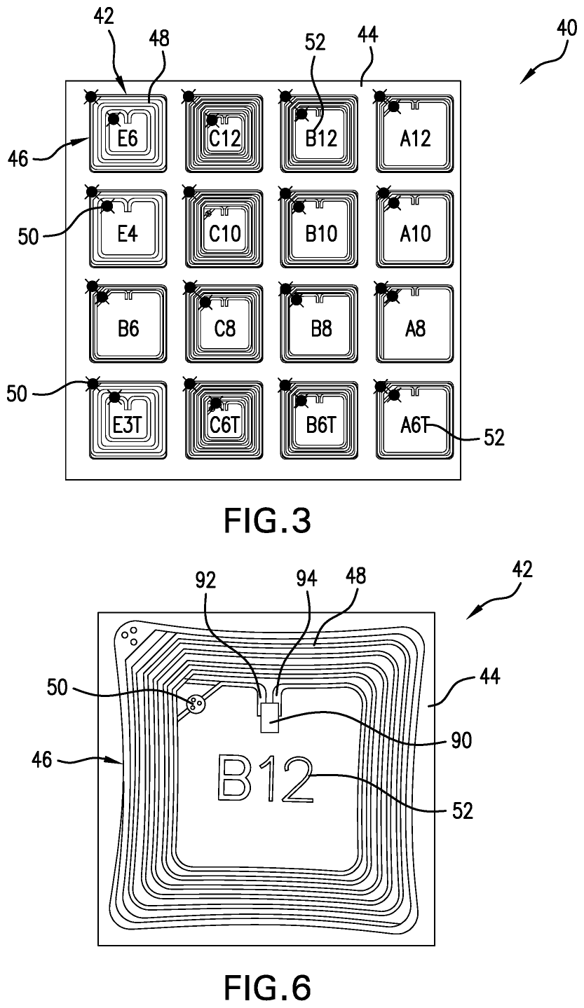

FIG. 3 is a top view of another RFID device assembly 40 similar to the assembly 10, but including twelve RFID devices 42 fabricated on a flexible substrate 44. The RFID devices 42 each include an RFID antenna 46 having a printed conductive trace 48 and vias 50. Each RFID device 42 also includes printed graphics 52 within the antenna 46 that identifies the device 42.

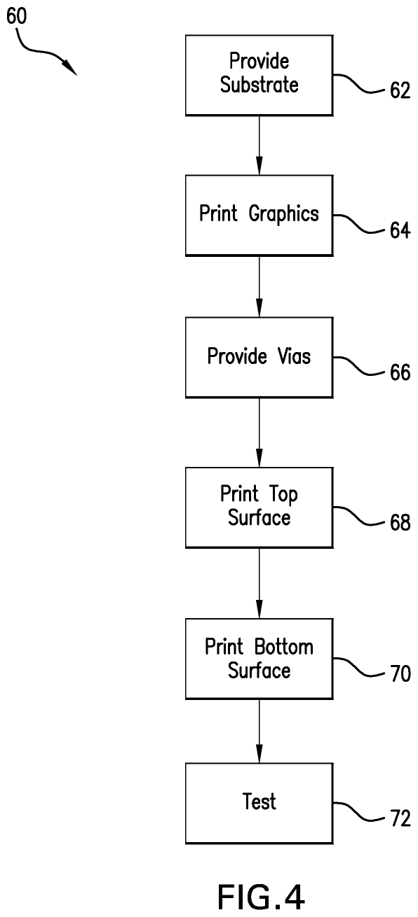

FIG. 4 is a flow diagram 60 of an FHE process for fabricating, for example, the assembly 40. The flexible substrate 44 is provided at box 62 and the graphics 52 are printed on the top surface and/or the bottom surface of the substrate 44 at box 64. The vias 50 are then provided through the substrate 44 at box 66. The antennas 46 are then printed on the top layer of the substrate 44 at box 68 and antennas (not shown) are printed on the bottom layer of the substrate 44 at box 70 so that the conductive ink flows into the vias 50 and makes an electrical connection between the antennas on the top and bottom surface of the substrate 44. The RFID devices 42 are then tested at box 72.

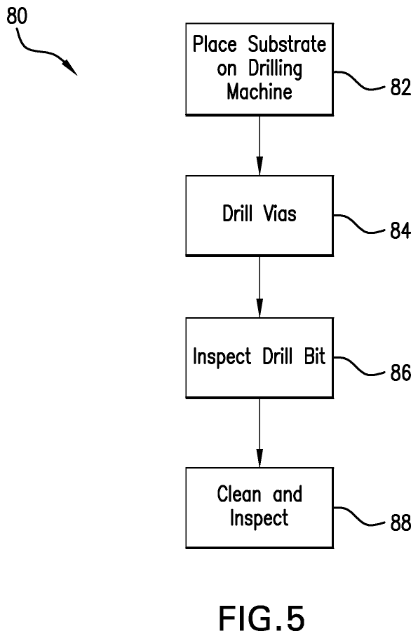

FIG. 5 is a flow diagram 80 showing a process for providing the vias 50. The substrate 44 is placed on a drilling machine at box 82 and the vias 50 are drilled by the machine at box 84. The drill bit on the machine is inspected for damage and wear every certain number of drilling operations, such as ten, at box 86. The vias 50 are then cleaned of debris and inspected at box 88.

Once the RFID devices 42 have been tested, they are separated from each other by cutting or dicing the substrate 44. An RFID chip 90 or other integrated circuit is then connected, for example, manually connected, to ends 92 and 94 of the antenna 46, as shown in FIG. 6.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A method for simultaneously printing a plurality of electrical devices, said method comprising:
providing a substrate having a top surface and a bottom surface;
providing vias through the substrate for all of the plurality of electrical devices;
printing circuit elements for the plurality of electrical devices on the top surface of the substrate using a conductive ink; and
printing circuit elements for the plurality of electrical devices on the bottom surface of the substrate using the conductive ink, wherein printing the circuit elements on the top and bottom surfaces of the substrate causes the ink to flow through the vias to provide an electrical connection between the circuit elements on the top and bottom surfaces of the substrate.

2. The method according to claim 1 further comprising printing graphics that identify the electrical devices on the top and/or bottom surfaces of the substrate.

3. The method according to claim 2 wherein printing the graphics is performed before the vias are provided.

4. The method according to claim 1 wherein providing the vias includes places the substrate in a drilling machine having a drill bit, drilling the vias through the substrate, periodically inspecting the drill bit and cleaning and inspecting the drilled vias.

5. The method according to claim 1 further comprising manually connecting an integrated circuit to the circuit elements.

6. The method according to claim 1 wherein the electrical devices are RFID devices and the circuit elements are RFID antennas.

7. The method according to claim 6 wherein the antennas include wound traces, and wherein at least some of the traces from one electrical device to another electrical device have different widths and/or a different number of turns and/or different trace spacing.

8. The method according to claim 1 wherein the substrate is a polyester substrate.

9. The method according to claim 1 wherein the conductive ink is a silver ink.

10. The method according to claim 1 wherein the substrate is a flexible substrate and the method prints flexible hybrid electronics (FHE).

11. The method according to claim 1 further comprising dicing the substrate to separate the plurality of electrical devices.

12. A method for flexible hybrid electronics (FHE) simultaneous printing of a plurality of RFID devices, said method comprising:
providing a flexible substrate having a top surface and a bottom surface;
providing vias through the substrate for all of the plurality of RFID devices;
printing wound antennas for the plurality of RFID devices on the top surface of the substrate using a conductive ink; and
printing wound antennas for the plurality of RFID devices on the bottom surface of the substrate using a conductive ink, wherein printing the wound antennas on the top and bottom surfaces of the substrate causes the ink to flow through the vias to provide an electrical connection between the wound antennas on the top and bottom surfaces.

13. The method according to claim 12 wherein the antennas include wound traces, and wherein at least some of the traces from one RFID device to another RFID device have different widths and/or a different number of turns and/or different trace spacing.

14. The method according to claim 12 further comprising printing graphics that identify the RFID devices on the top and/or bottom surfaces of the substrate.

15. The method according to claim 14 wherein printing the graphics is performed before the vias are provided.

16. The method according to claim 12 further comprising manually connecting an RFID chip to the wound antennas.

17. A system for simultaneously printing a plurality of electrical devices, said system comprising:
means for providing a substrate having a top surface and a bottom surface;
means for providing vias through the substrate for all of the plurality of electrical devices;
means for printing circuit elements for the plurality of electrical devices on the top surface of the substrate using a conductive ink; and
means for printing circuit elements for the plurality of electrical devices on the bottom surface of the substrate using the conductive ink, wherein the means for the circuit elements on the top and bottom surfaces of the substrate causes the ink to flow through the vias to provide an electrical connection between the circuit elements on the top and bottom surfaces of the substrate.

18. The system according to claim 17 further comprising means for printing graphics that identify the electrical devices on the top and/or bottom surfaces of the substrate.

19. The system according to claim 18 wherein the means for printing the graphics prints the graphics before the means for printing the vias prints the vias.

20. The system according to claim 17 wherein the electrical devices are RFID devices and the circuit elements are RFID antennas.
